(19) United States
(12) Patent Application Publication
(10) Pub. No.: US 2013/0244627 A1
(43) Pub. Date: Sep. 19, 2013

(54) METHOD FOR PROVIDING PHONE BOOK SERVICE AND ASSOCIATED ELECTRONIC DEVICE THEREOF

(71) Applicant: SAMSUNG ELECTRONICS CO., LTD., Gyeonggi-do (KR)

(72) Inventor: Su-Byung Kang, Yongin-si (KR)

(73) Assignee: SAMSUNG ELECTRONICS CO., LTD, Gyeonggi-do (KR)

(21) Appl. No.: 13/779,490

(22) Filed: Feb. 27, 2013

(30) Foreign Application Priority Data
Mar. 13, 2012 (KR) 10-2012-0025451

(51) Int. Cl. H04W 4/00

(52) U.S. Cl. CPC H04W 4/00
USPC 455/414.1

(57) ABSTRACT

A method for providing a phone book service and an electronic device thereof are provided. In the method, an attempted call to a specific phone number is detected. Whether the specific phone number invalid is determined. When the specific phone number is invalid, information associated with the specific phone number is deleted.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Mar. 13, 2012 and assigned Serial No. 10-2012-0025451, the entire disclosure of which is hereby incorporated by reference.

### TECHNICAL FIELD OF THE INVENTION

The present invention relates generally to electronic communication devices, and more particularly, to a method for providing a phone book service and an associated electronic device.

### BACKGROUND OF THE INVENTION

Recently, use of electronic devices such as mobile electronic terminals, portable terminals, and the like have increased, and accordingly, service providers have developed electronic devices having enhanced convenient functions.

Particularly, electronic devices having a communication function that provide a phone book for storing a phone number and information associated with the phone number (e.g., a name, a photo, an electronic mail, other phone numbers, an address, an anniversary, a group, and the like), and performing an associated function for a relevant phone number through retrieval.

Particularly, to allow a user to more easily communicate with a desired user, the phone book of the electronic device provides an associated function for providing a communication list including multiple phone numbers (or contact information) of a counterpart with whom the user has recently communicated to perform communication with a relevant phone number or transmit a Short Message Service (SMS) or a Multimedia Message Service (MMS). At this point, since the communication list has a predetermined size, it can include only a limited number of phone numbers. Therefore, a method for efficiently managing the communication list needs to be proposed.

### SUMMARY OF THE INVENTION

To address the above-discussed deficiencies of the prior art, it is a primary object to provide a method and an apparatus for providing a phone book service in an electronic device.

Another aspect of the present invention is to provide a method and an apparatus for managing a communication list by determining whether a phone number to which communication is attempted is valid when an electronic device attempts a call.

Still another aspect of the present invention is to provide a method and an apparatus for deleting information associated with an invalid phone number in an electronic device.

In accordance with an aspect of the present invention, a method of an electronic device for providing a phone book service is provided. The method includes detecting an attempted call to a specific phone number, determining whether the specific phone number is a valid phone number, and when the specific phone number is an invalid phone number, deleting information associated with the specific phone number.

In accordance with another aspect of the present invention, an electronic device for providing a phone book service is provided. The device includes a display unit, at least one processor, a memory, and at least one module stored in the memory and configured for being executed by the at least one processor, wherein the module includes instructions for detecting an attempted call to a specific phone number, determining whether the specific phone number is a valid phone number, and when the specific phone number is an invalid phone number, deleting information associated with the specific phone number.

In accordance with still another aspect of the present invention, an electronic device for providing a phone book service is provided. The device includes means for detecting an attempted call to a specific phone number, means for determining whether the specific phone number is a valid phone number, and means for, when the specific phone number is an invalid phone number, deleting information associated with the specific phone number.

In accordance with yet another aspect of the present invention, a computer readable storage medium is provided. The computer readable storage medium stores one or more programs including instructions for allowing an electronic device to perform a method of claim 1 when the instructions are executed by the electronic device.

In accordance with further another aspect of the present invention, a method of an electronic device, for providing a phone book service is provided. The method includes determining whether a phone number to which a call is attempted is valid, and displaying a communication list in which the phone number is excluded if the phone number is an invalid phone number and included if the phone number is a valid phone number.

In accordance with still further another aspect of the present invention, an electronic device for providing a phone book service is provided. The device includes a display unit, at least one processor, a memory, and at least one module stored in the memory and configured for being executable by the at least one processor, wherein the module includes instructions for determining whether a phone number to which a call is attempted is valid and displaying a communication list in which the phone is excluded if the phone number is an invalid phone number and included if the phone number is a valid phone number.

Other aspects, advantages and salient features of the invention will become apparent to those skilled in the art from the following detailed description, which, taken in conjunction with the annexed drawings, discloses certain embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example electronic device according to an certain embodiments of the present invention;

FIG. 2 illustrates an example operating procedure for managing a communication list in an electronic device according to certain embodiments of the present invention;

FIG. 3 illustrates an example operating procedure for managing a communication list in an electronic device according to certain embodiments of the present invention; and

FIGS. 4A-C illustrate an example screen configuration for a communication list and phone number retrieval results when an electronic device tries a call to an invalid phone number according to certain embodiments of the present invention.

Throughout the drawings, like reference numerals will be understood to refer to like parts, components and structures.

### DETAILED DESCRIPTION OF THE INVENTION

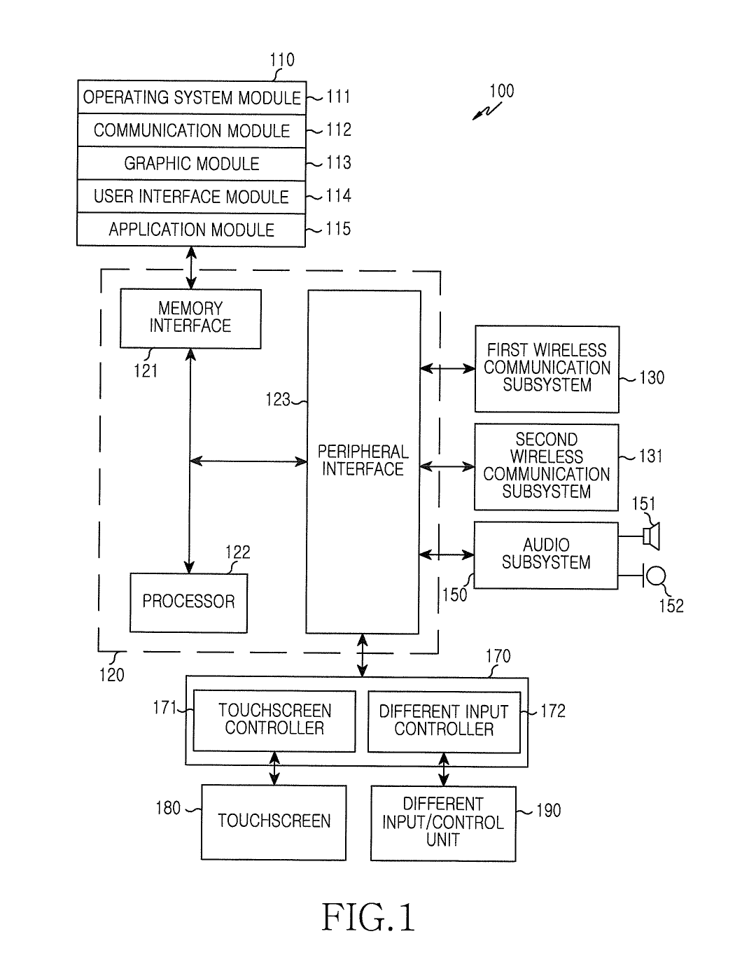

FIGS. 1 through 4C, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic communication devices. The following description with reference to the accompanying drawings is provided to assist in a comprehensive understanding of certain embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of certain embodiments of the present invention are provided for illustration purpose only and not for the purpose of limiting the invention as defined by the appended claims and their equivalents.

Certain embodiments of the present invention provide a method for providing a phone book service and an associated electronic device.

In the following description, an electronic device denotes all of a mobile communication terminal providing a communication function, a smart phone, a portable phone, a Tablet Persona Computer (PC), etc. Also, a valid phone number denotes a phone number coinciding with a predetermined phone number form and for which a corresponding terminal exists. An invalid phone number denotes a phone number that does not coincide with a predetermined phone number form or a phone number for which a corresponding terminal does not exist.

FIG. 1 illustrates an electronic device according to certain embodiments of the present invention.

As illustrated in FIG. 1, an electronic device 100 includes a memory 110, a processor unit 120, a first wireless communication subsystem 130, a second wireless communication system 131, an audio subsystem 150, a speaker 151, a microphone 152, an input/output system WO system) 170, a touchscreen 180, and a different input/control unit 190. Here, multiple memories 110 may be provided.

The processor unit 120 may include a memory interface 121, one or more processors 122, and a peripheral interface 123. In certain embodiments, the entire processor unit 120 may be referred to as a processor. The memory interface 121, one or more processors 122 and/or the peripheral interface 123 may be separate elements or may be integrated in one or more integrated circuits.

The processor 122 executes various software programs to execute various functions for operations of the electronic device 100, and perform processes and controls for voice communication and data communication. In addition to these general functions, the processor 122 executes a specific software module (command set) stored in the memory 110 to perform a function corresponding to the executed module. The processor 122 may directly perform the function of a phone book application module included in an application module 115 according to an certain embodiments of the present invention.

The peripheral interface 123 connects the I/O subsystem 130 of the electronic device 100 and various peripheral processors 122 with the processor 122 and the memory 110.

The first wireless communication subsystem 130 and the second wireless communication subsystem 131 perform a communication function for transmitting/receiving a signal to/from an external apparatus. Each of the first wireless communication subsystem 130 and the second wireless communication subsystem 131 may include a Radio Frequency (RF) transceiver and/or a light (for example, an infrared) transceiver. The first wireless communication subsystem 130 and the second wireless communication subsystem 131 may be classified depending on a communication network supported by the electronic device 100. For example, the electronic device 100 may include a wireless communication subsystem that supports one of a GSM network, an EDGE network, a CDMA network, a W-CDMA network, an LTE network, an OFDMA network, a Wi-Fi network, a WiMax network and/or a Bluetooth network. The wireless communication subsystem according to certain embodiments of the present invention is not limited to a wireless communication subsystem that supports these networks but may be a wireless communication subsystem that supports other networks. The first wireless communication subsystem 130 or the second wireless communication subsystem 131 transmits a signal requesting a call connection to a specific phone number to a base station corresponding to a relevant network, and receives a response signal to a call connection from the base station corresponding to the relevant network.

The audio subsystem 150 combines the speaker 151 with the microphone 152 to perform voice recognition, voice duplication, digital recording, and input and output functions of an audio stream for a telephone function. That is, the audio subsystem 150 outputs an audio signal via the speaker 151 and receives an audio signal via the microphone 152. The audio subsystem 150 receives a data stream via the peripheral interface 123 of the processor unit 120, converts the received data stream to an electric stream, and provides the electric stream (signal) to the speaker 151. The audio subsystem 150 receives an electric stream from the microphone 152, converts the electric stream to an audio data stream, and provides the audio data stream to the peripheral interface 123. The audio subsystem 150 performs a function for outputting a message regarding an invalid phone number in the form of an audio signal via the speaker 151 when a call is tried.

The speaker 151 converts an electric stream received from the audio subsystem 150 to a sound wave which can be heard by a human being and outputs the same. The microphone 152 converts a sound wave transferred from a human being or other sound sources to an electric stream.

The I/O subsystem 170 may include a touchscreen controller 171 and/or a different input controller 172. The touchscreen controller 171 may be coupled to the touchscreen 180. Touchscreen 180 and the touchscreen controller 171 may detect a contact and movement or stoppage of these using an arbitrary multi touch detect technology including other proximity sensor arrangements or other elements as well as capacitive, resistive, infrared, and surface acoustic wave technologies for determining one or more contact points with the touchscreen 180. The different input controller 172 may be coupled to the different input/control unit 190. The different input/control unit 190 may include one or more up/down buttons for controlling volume. Also, the button may be a push button, a rocker button, and the like. The different input/control unit 190 may be a rocker switch, a thumb-wheel, a dial, a stick, and/or a pointer device such as a stylus.

The touchscreen 180 provides an input/output interface between the electronic device 100 and a user. That is, the touchscreen 180 provides an interface for a user's touch input/output. Specifically, the touchscreen 180 serves as a medium for detecting a user's touch input to provide the same to the electronic device 100, and displaying an output from the electronic device 100 to provide the same to the user. Also, the touchscreen 180 provides a visual output configured using text, graphics, video, and a combination of one or more of these. The touchscreen 180 may use various known conventional display technologies. For example, the touchscreen 180 may use a Liquid Crystal Display (LCD), a Light Emitting Diode (LED), a Light Emitting Polymer Display (LPD), an Organic Light Emitting Diode (OLED), an Active Matrix Organic Light Emitting Diode (AMOLED) or a Flexible LED (FLED). The touchscreen of the present invention is not limited to a touchscreen that uses these display technologies.

In certain embodiments, the touchscreen 180 may output a communication list including a phone number and phone number retrieval results. In the case where the electronic device does not have the touchscreen 180, the electronic device may output a communication list and phone number retrieval results via a separate display unit. Here, the communication list denotes a list representing a communication history of the electronic device. The communication list may include phone numbers to which a call has been performed or attempted for a specified time by the electronic device. Also, the communication list may include a specified number of phone numbers to which an associated call has been performed or attempted recently among multiple phone numbers to which a call has been performed or attempted by the electronic device.

The memory 110 may be coupled to the memory interface 121. The memory 110 may include a high speed random access memory such as one or more magnetic disk storage devices and/or a non-volatile memory, one or more optical storage devices and/or a flash memory (for example, NAND, NOR).

The memory 110 stores software. A software element includes an operating system module 111, a communication module 112, a graphic module 113, a user interface module 114, and an application module 115. Also, since a module which is an element of software may be expressed in terms of a set of instructions, the module is also expressed as an instruction set. The module is also expressed as a program.

The memory 110 may store one or more modules including instructions for performing various embodiments of the present invention.

An operating system software 111 (for example, a built-in operating system such as WINDOWS, LINUX, Darwin, RTXC, UNIX, OS X or VxWorks) includes various software elements controlling a general system operation. For example, a control of the general system operation denotes a memory management and control, a storage hardware (device) control and management, a power control and management, etc. The operating system software performs a function for smoothing communication between various hardwares (devices) and software elements (modules).

The communication module 112 includes an instruction for enabling communication with other electronic devices such as a computer, a server and/or a portable terminal, etc. via the wireless communication subsystems 130, 131 or an external port 260.

The graphic module 113 includes various software elements for displaying graphics on the touchscreen 140. Graphics include text, a web page, an icon, a digital image, a video, animation, etc. The graphic module 113 includes an instruction for controlling to display a communication list or phone number retrieval results provided from the application module 115 on the touchscreen 140.

The user interface module 114 includes various software elements related to a user interface. The user interface module 114 includes content as to how a state of a user interface is changed or under which condition a change of a user interface state is performed. The user interface module 114 receives a phone number via the touchscreen 140 or the different input/control unit 150.

The application module 115 includes applications, such as a browser, an electronic mail, an instant message, a word processor, a keyboard emulation, an address book, a touch list, a widget, a Digital Right Management (DRM), voice recognition, voice duplication, a position determining function, a location based service, and phone book applications. Particularly, a phone book application according to certain embodiments performs functions for determining whether a specific phone number to which a call is attempted is a valid phone number when a call is attempted to the specific phone number, and storing and managing information of a communication list and a phone number depending on the determination result.

That is, when the specific phone number to which a call is attempted is an invalid phone number, the phone book application performs a function for excluding the specific phone number from the communication list and deleting a record associated with the specific phone number. That is, the phone book excludes communication information associated with invalid phone numbers and includes only communication information associated with a valid phone numbers when calls to the invalid phone numbers have been attempted by the electronic device. Also, the phone book provides only information regarding valid phone numbers by deleting information related to the invalid phone number. The phone book application module may determine whether a relevant phone number is a valid phone number via a response of a network to an attempted call, that is, a response signal received from a base station during an attempted call. Also, the phone book application module may compare a form of an input phone number with a specified phone number form to determine whether the relevant phone number is a valid phone number when a user inputs the phone number for an attempted call.

The memory 110 may further include an additional module (e.g., instructions) besides the above-described modules and may not include some other instructions of the above-described modules.

Various functions of the above-described electronic device 100 according to the embodiment of the present invention may be executed by one or more stream processings and/or a hardware including an Application Specific Integrated Circuit (ASIC) and/or software and/or a combination of these.

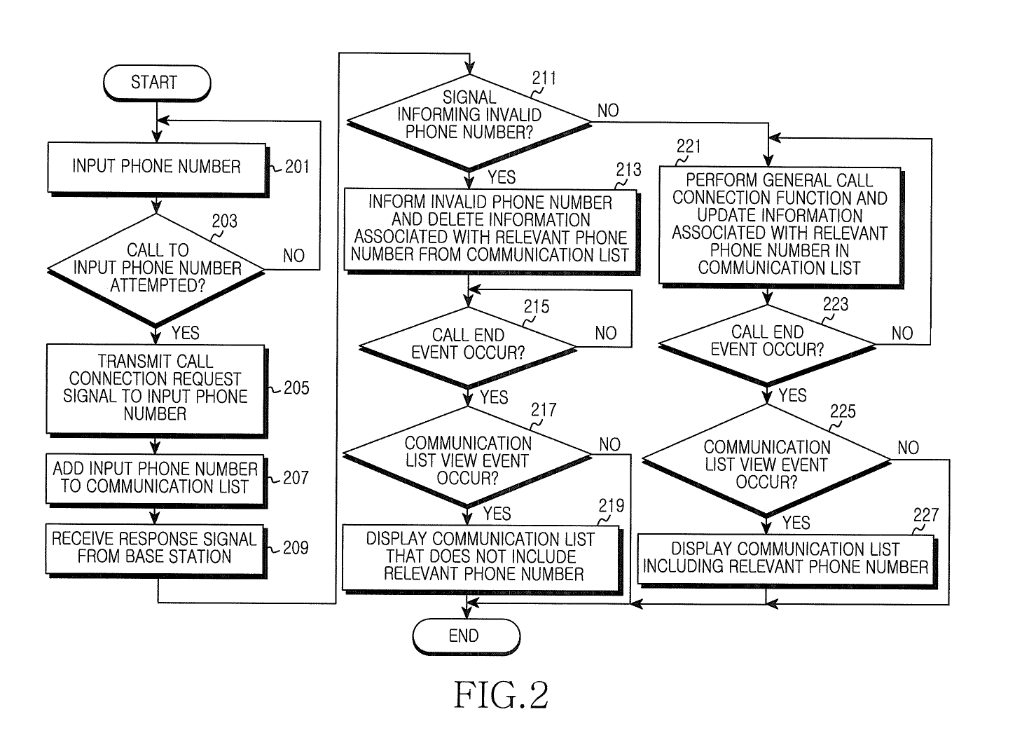

FIG. 2 illustrates an example operating procedure for managing a communication list in an electronic device according to certain embodiments of the present invention.

Referring to FIG. 2, the electronic device receives a phone number via user input in step 201. At this point, the electronic device receives a phone number via a screen touch or a key button input and determines the received phone number.

After that, the electronic device proceeds to step 203 to determine whether a call to the received phone number is attempted or tried. That is, after the phone number is inputted, the electronic device determines whether a call menu is selected under a user's control. When a call to the input phone number is not attempted, the electronic device returns to step 201.

In contrast, when a call to the input phone number is attempted, the electronic device proceeds to step 205 to transmit a signal requesting a call connection to the input phone number, and adds the input phone number to a communication list in step 207. Here, an operation performance sequence of step 205 and step 207 may change depending on a design scheme. That is, the electronic device may simultaneously perform step 205 and step 207, and/or may perform the operation of step 207 and then perform the operation of step 205.

After that, the electronic device receives a response signal to a call connection request from a base station in step 209 and proceeds to step 211 to determine whether the response signal received from the base station is a signal representing an invalid phone number. That is, the electronic device determines whether the response signal received from the base station represents that an electronic device corresponding to the relevant phone number does not exist. At this point, a fact that the electronic device corresponding to the relevant phone number does not exist denotes that the relevant phone number is a phone number not allocated to any electronic device.

When the response signal received from the base station represents an invalid phone number, the electronic device proceeds to step 213 to output a signal representing that the input phone number is a phone number that does not exist, and delete the relevant phone number and information the associated phone number added to the communication list. Here, the signal representing that the input phone number is a phone number that does not exist may be any suitable type, such as an audio signal output to the speaker or a graphic signal output via the screen.

After that, the electronic device determines whether a call end event occurs in step 215. At this point, the call end event may be generated by selection of a call end menu under a user's control or may be generated at a specified point after a signal representing the input phone number is a phone number that does not exist is outputted.

When the call end event occurs, the electronic device proceeds to step 217 to determine whether a communication list view event occurs. At this point, the communication list view event may occur when a communication list menu is selected by a user's touch or key button input.

When the communication list view event does not occur, the electronic device ends the algorithm according to the embodiment of the present invention.

In contrast, when the communication list view event occurs, the electronic device proceeds to step 219 to display a communication list that does not include a phone number to which a call has been attempted and determined to be invalid. That is, the electronic device excludes phone numbers to which a call has been tried and phone numbers determined as invalid phone numbers among phone numbers to which calls have been performed, and displays a communication list including the rest of the phone numbers. After that, the electronic device ends the algorithm according to the embodiment of the present invention.

In contrast, when the response signal received from the base station is not a signal representing an invalid phone number, the electronic device proceeds to step 221 to perform a general call connection function and determine that the input phone number is a valid phone number to update information regarding the relevant phone number in the communication list. That is, the electronic device updates communication related information (e.g., calling time and communication time) associated with the relevant phone number in the communication list. Here, the call connection function denotes a call connection signal output, a call connection, and a function for transmitting/receiving a signal to/from a counterpart electronic device.

After that, the electronic device determines whether a call end event occurs in step 223. At this point, the call end e vent may be generated by selection of a call end menu under a user's control or may be generated at a predetermined point after a signal representing the input phone number that does not exist is outputted.

When the call end event occurs, the electronic device proceeds to step 227 to determine whether a communication list view event occurs. At this point, the communication list view event may occur when a communication list menu is selected by a user's touch or key button input. When the communication list view event does not occur, the electronic device ends the algorithm according to the embodiment of the present invention.

In contrast, when the communication list view event occurs, the electronic device proceeds to step 227 to display a communication list including a phone number to which a call has been performed. That is, the electronic device excludes phone numbers to which a call has been attempted and phone numbers determined as invalid phone numbers among phone numbers to which a call has been performed, and displays a communication list including phone numbers determined as valid phone numbers. After that, the electronic device ends the algorithm according to the embodiment of the present invention.

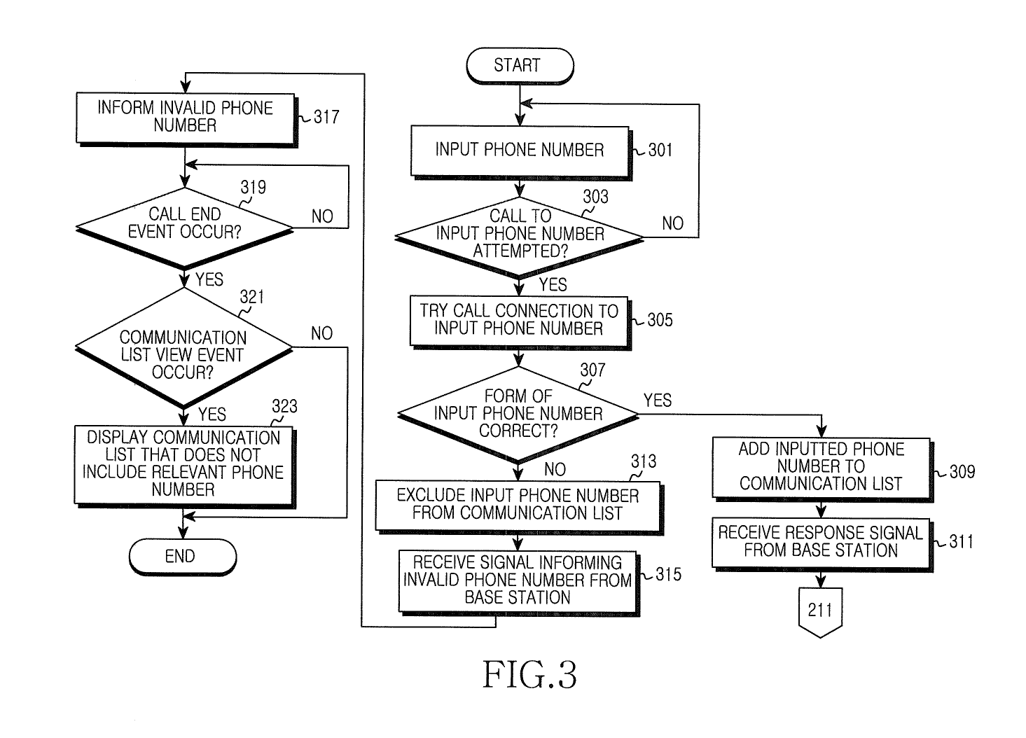

FIG. 3 illustrates an example operating procedure for managing a communication list in an electronic device according to certain embodiments of the present invention.

Referring to FIG. 3, the electronic device receives a phone number via user input in step 301. At this point, the electronic device receives a phone number via a screen touch or a key button input and determines the received phone number.

After that, the electronic device proceeds to step 303 to determine whether a call to the received phone number is attempted. That is, the electronic device determines whether a call menu is selected under a user's control after the phone number is inputted. When a call to the input phone number is not attempted, the electronic device returns to step 301.

In contrast, when a call to the input phone number is attempted, the electronic device proceeds to step 305 to transmit a signal requesting a call connection to the inputted phone number and determines whether the form of the input phone number is correct in step 307. That is, the electronic device determines whether the form of the inputted phone number coincides with a previously stored phone number form. For example, the electronic device stores information associated with a prefix for each nation, a prefix for each region, a prefix for a mobile phone for a phone number in advance, and when a prefix of an input phone number is determined as, for example “541”, the electronic device determines whether a nation prefix, a region prefix or a mobile phone prefix corresponding to “541” exist.

When the form of the inputted phone number coincides with the previously stored phone number form, the electronic device proceeds to step 309 to add the inputted phone number to the communication list, and receives a response signal from a base station in step 311. After that, the electronic device proceeds to step 211 of FIG. 2 to perform operations of step 211 to step 227.

In contrast, when the form of the input phone number does not coincide with the previously stored phone number form, the electronic device determines that the inputted phone number is an invalid phone, number and proceeds to step 313 to exclude the input phone number from the communication list. At this point, the electronic device deletes all records associated with the inputted phone number. After that, the electronic device receives a signal informing an invalid phone number from the base station in step 315, and proceeds to step 317 to output a signal representing that the input phone number is an invalid phone number.

After that, the electronic device determines whether a call end event occurs in step 319. At this point, the call end event may be generated by selection of a call end menu under a user's control or may be generated at a predetermined point after a signal representing the input phone number does not exist is outputted.

When the call end event occurs, the electronic device proceeds to step 321 to determine whether a communication list view event occurs. At this point, the communication list view event may occur when a communication list menu is selected via user input. When the communication list view event does not occur, the electronic device ends the algorithm according to the embodiment of the present invention.

In contrast, when the communication list view event occurs, the electronic device proceeds to step 323 to display a communication list does not include a phone number to which a call has been attempted. That is, the electronic device excludes phone numbers to which calls have been attempted and phone numbers determined as invalid phone numbers among multiple phone numbers to which call has been performed, and displays a communication list only including those phone numbers determined as valid numbers. After that, the electronic device ends the algorithm according to the embodiments of the present invention.

Though the method allowing the electronic device to transmit a signal requesting a call connection to the inputted phone number, determine whether the inputted phone number is a valid phone number, and receive a response signal from the base station has been described in FIG. 3, a method allowing an electronic device to determine whether an inputted phone number is a valid phone number first when a call to the inputted phone number is attempted, and transmit or not transmit a signal requesting a call connection depending on whether the inputted phone number is the valid phone number may be used. That is, the electronic device may determine whether the inputted phone number is valid when a call to the inputted phone number is attempted, does not transmit a signal requesting a call connection when the inputted phone number is not valid, and output a signal representing that the inputted phone number is not valid via a speaker or information displayed on a screen.

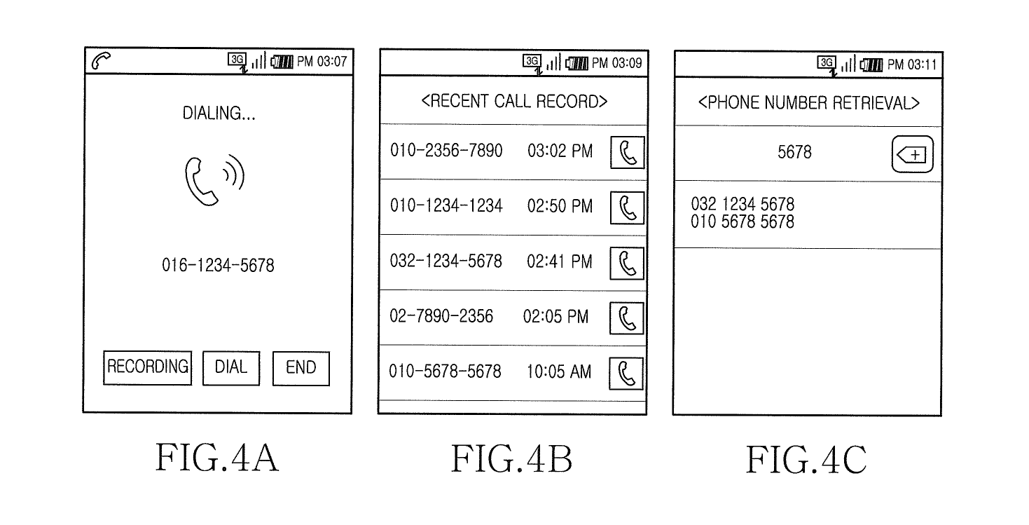

FIGS. 4A-C illustrate an example screen configuration for a communication list and phone number retrieval results when an electronic device attempts a call to an invalid phone number according to certain embodiments of the present invention.

First, as illustrated in FIG. 4A, an electronic device may receive a phone number “016-1234-5678” under a user's control, and then try a call connection to the phone number “016-1234-5678”. At this point, when receiving a signal representing that an electronic device corresponding to the phone number “016-1234-5678” does not exist from a base station, the electronic device may determine the phone number “016-1234-5678” as an invalid phone number. Also, in the case where a prefix coinciding with the prefix “016” of the phone number “016-1234-5678” does not exist among a prefix allocated for each nation, a prefix for each region, and a previously stored mobile phone prefix, the electronic device may determine the phone number “016-1234-5678” as an invalid phone number.

As illustrated in FIG. 4A, when determining that the phone number “016-1234-5678” to which a call has been attempted is an invalid phone number, the electronic device deletes all information associated with the phone number “016-1234-5678”. Accordingly, as illustrated in FIG. 4B, when displaying a communication list representing a recent communication history of the electronic device, the electronic device may provide a communication list excluding the invalid phone number “016-1234-5678” to a user. Also, as illustrated in FIG. 4C, the electronic device may prevent the invalid phone number “016-1234-5678” from being retrieved when the user retrieves a phone number.

Though the embodiment of the present invention has described a method allowing an electronic device to add a relevant phone number to a communication list when a user attempts a call, determine whether the relevant phone number is a valid phone number, and when the relevant phone number is not a valid phone number, delete the relevant phone number from the communication list, a method for determining whether a relevant phone number is a valid phone number when a call is attempted, when the relevant phone number is not a valid phone number, deleting information associated with the relevant phone number, and when the relevant phone number is a valid phone number, adding the information related to the relevant phone number to a communication list may be used.

Also, though the above embodiment has described a procedure for displaying a communication list after a call is attempted by an electronic device, a method for selecting a communication list menu under a user's control regardless of a call trial point, excluding a phone number determined as an invalid phone number among phone numbers to which a call has been tried recently and phone numbers to which a call has been performed, and displaying a communication list including the rest of phone numbers may be used.

Various embodiments of the present invention and all function operations described in the specification may be implemented using a computer software, firmware, or hardware including the structure and equivalents thereof disclosed in the specification, or a combination of one or more of these. Also, the embodiments of the present invention described in the specification may be executed by one or more computer program products, that is, data processing devices, or may be implemented by one or more modules of computer program instructions encoded on a computer readable medium for controlling operations of this device.

The computer readable medium may be a machine readable storage medium, a machine readable storage board, a memory unit, construction of a material influencing a machine readable radio stream, or a combination of one or more of these. The terminology of the data processing device includes a programmable processor, a computer, or all devices, apparatuses, and a machine for processing data including a multiple processor or a computer, for example. The apparatus may include a code added to a hardware to generate an execution environment for a relevant computer program, for example, a code configuring a processor firmware, a protocol stack, a database management system, an operating system or a combination of one or more of these.

The present invention determines whether a specific phone number is a valid phone number when a call to the specific phone number is tried at an electronic device, and deletes a communication record regarding an invalid phone number and related information to generate a communication list excluding the invalid phone number, thereby providing only the valid phone number via the communication list and improving user convenience. Also, the present invention may prevent an invalid phone number from being retrieved when a phone number is retrieved at an electronic device, thereby preventing, the number of times of touches from increasing due to retrieval of the invalid phone number.

Methods according to the embodiments described in claims and/or specification of the present invention may be implemented in the form of hardware, software, or a combination of hardware and software.

In case of implementation in the form of software, a computer readable storage medium storing one or more programs (software modules) may be provided. The one or more programs stored in the computer readable storage medium are configured for execution by one or more processors inside the electronic device. The one or more programs include instructions for allowing the electronic device to execute methods according to the embodiments described in claims and/or specification of the present invention.

These programs (software modules, software) may be stored in a random access memory, a non-volatile memory including a flash memory, Read Only Memory (ROM), an Electrically Erasable Programmable Read Only Memory (EEPROM), a magnetic disc storage device, a Compact Disc (CD)-ROM, Digital Versatile Discs (DVDs) or other types of optical storage devices, and a magnetic cassette. Alternatively, these programs may be stored in a memory configured in a combination of some or all of these. Also, a plurality of respective memories may be provided.

Also, these programs may be stored in an attachable storage device that can access the electronic device via a communication network such as the Internet, Intranet, Local Area Network (LAN), Wide LAN (WLAN), and a Storage Area Network (SAN), or a communication network configured in combination of these. This storage device may access the electronic device via an external port.

Also, a separate storage device on a communication network may access a portable electronic device.

Although the invention has been shown and described with reference to certain embodiments thereof, it will be understood by those skilled in the art that various changes in form and details may be made therein without departing from the spirit and scope of the invention as defined by the appended claims and their equivalents. Therefore, the scope of the present invention should not be limited to the above-described embodiments but should be determined by not only the appended claims but also the equivalents thereof.

What is claimed is:

1. A method of an electronic device for providing a phone book service, the method comprising:
detecting an attempted call to a specific phone number;
determining whether the specific phone number is a valid phone number; and
when the specific phone number is an invalid phone number, deleting information associated with the specific phone number.

2. The method of claim 1, further comprising:
detecting generation of a communication list view event; and
displaying a communication list excluding the invalid phone number from among a plurality of phone numbers to which associated calls have been attempted by the electronic device and comprise valid phone numbers.

3. The method of claim 1, further comprising, when the specific phone number is a valid phone number, storing information associated with the specific phone number.

4. The method of claim 1, wherein determining whether the specific phone number is the valid phone number comprises:
requesting a base station to perform a call connection;
receiving a response signal to a call connection request from the base station;
determining whether the response signal represents that another electronic device corresponding to the specific phone number does not exist; and
when the response signal represents that the electronic device corresponding to the specific phone number does not exist, determining that the specific phone number is an invalid phone number, and when the response signal represents that the electronic device corresponding to the specific phone number exists, determining that the specific phone number is a valid phone number.

5. The method of claim 1, wherein determining whether the specific phone number is the valid phone number comprises:
comparing a phone number form set in advance with a form of the specific phone number; and
when the form of the specific phone number coincides with the phone number form previously determined, determining that the specific phone number is a valid phone number, and when the form of the specific phone number does not coincide with the phone number determined previously, determining that the specific phone number is an invalid phone number.

6. The method of claim 1, further comprising:
after the detecting of the attempted call to the specific phone number, adding the specific phone number to a communication list; and
when the specific phone number is an invalid phone number, deleting the specific phone number from the communication list.

7. An electronic device configured to provide a phone book service, the device comprising:
a display unit;
at least one processor;
a memory; and
at least one module stored in the memory and configured to be executed by the at least one processor,
wherein the module comprises instructions for detecting an attempted call to a specific phone number, determining whether the specific phone number is a valid phone number, and when the specific phone number is an invalid phone number, deleting information associated with the specific phone number.

8. The electronic device of claim 7, wherein the module comprises instructions for detecting generation of a communication list view event, and displaying a communication list excluding an invalid phone number among a plurality of phone numbers to which associated calls have been attempted by the electronic device and comprise a valid phone number.

9. The electronic device of claim 7, wherein the module comprises instructions for storing information regarding the specific phone number when the specific phone number is a valid phone number.

10. The electronic device of claim 7, wherein the module comprises instructions for requesting a base station to perform a call connection,
receiving a response signal to a call connection request from the base station,
determining whether the response signal represents that another electronic device corresponding to the specific phone number does not exist, and
when the response signal represents that the electronic device corresponding to the specific phone number does not exist, determining that the specific phone number is an invalid phone number, and when the response signal represents that the electronic device corresponding to the specific phone number exists, determining that the specific phone number is a valid phone number.

11. The electronic device of claim 7, wherein the module comprises an instruction for comparing a phone number form previously determined with a form of the specific phone number, when the form of the specific phone number coincides with the phone number form set in advance, determining that the specific phone number is a valid phone number, and when the form of the specific phone number does not coincide with the phone number form previously determined, determining that the specific phone number is an invalid phone number.

12. The electronic device of claim 7, wherein the module comprises an instruction for, after the detecting of the attempted call to the specific phone number, adding the specific phone number to a communication list, and when the specific phone number is an invalid phone number, deleting the specific phone number from the communication list.

13. An electronic device configured to provide a phone book service, the device comprising:
means for detecting an attempted call to a specific phone number;
means for determining whether the specific phone number is a valid phone number; and
means for, when the specific phone number is an invalid phone number, deleting information associated with the specific phone number.

14. The electronic device of claim 13, further comprising:
means for detecting generation of a communication list view event; and
means for displaying a communication list excluding an invalid phone number among a plurality of phone numbers to which associated calls have been attempted by the electronic device and comprise a valid phone number.

15. A computer readable storage medium configured to store one or more programs comprising instructions for, when the instructions are executed by an electronic device, allowing the electronic device to perform a method of claim 1.

16. A method of an electronic device for providing a phone book service, the method comprising:
determining whether a phone number to which an attempted call is a valid phone number; and
displaying a communication list excluding an invalid phone number and comprising a valid phone number.

17. An electronic device configured to provide a phone book service, the device comprising:
a display unit;
at least one processor;
a memory; and
at least one module stored in the memory and configured to be executed by the at least one processor,
wherein the module comprises instructions for determining whether a phone number to which an attempted call is a valid phone number and displaying a communication list excluding an invalid phone number and comprising a valid phone number.

18. The electronic device of claim 17, wherein the module comprises instructions for:
detecting generation of a communication list view event; and
displaying a communication list excluding the invalid phone number from among a plurality of phone numbers to which associated calls have been attempted by the electronic device and comprise valid phone numbers.

19. The electronic device of claim 17, wherein the module comprises instructions for, when the specific phone number is a valid phone number, storing information associated with the specific phone number.

20. The electronic device of claim 17, wherein the module comprises instructions for:
when determining whether the specific phone number is the valid phone number comprises:
requesting a base station to perform a call connection;
receiving a response signal to a call connection request from the base station;
determining whether the response signal represents that another electronic device corresponding to the specific phone number does not exist; and
when the response signal represents that the electronic device corresponding to the specific phone number does not exist, determining that the specific phone number is an invalid phone number, and when the response signal represents that the electronic device corresponding to the specific phone number exists, determining that the specific phone number is a valid phone number.
